(19) United States
(12) Patent Application Publication
(10) Pub. No.: US 2003/0048780 A1
(43) Pub. Date: Mar. 13, 2003

(54) Supporting real-time multimedia applications via a network address translator

(76) Inventor: Bounthavivone K. Phomsopha, Portland, OR (US)

Correspondence Address: PILLSBURY WINTHROP, LLP, P.O. BOX 10500, MCLEAN, VA, 22102, US

(21) Appl. No.: 09/948,709

(22) Filed: Sep. 10, 2001

(51) Int. Cl. H04L 12/56

(52) U.S. Cl. 370/389; 370/475

(57) ABSTRACT

An arrangement is provided for enabling real-time data streaming via network address translator. Existing network address translator configuration is utilized to perform user datagram protocol priming after a TCP connection is established. The user datagram protocol priming establishes a data channel, through which data can be streamed between two network end points via an existing network address translator.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to communications. Other aspects of the present invention relate to data streaming.

Network Address Translator (NAT) enables private end points in a private address space to communicate, across IP networks, with other end points that are in a public or routable address space by translating a private address of a private end point into a routable public address. With a NAT, multiple private end points can share a single Internet connection. FIG. 1 illustrates a scheme in which multiple clients 110, 102, 105 share a single Internet connection and communicate, via a NAT, with the end points outside of the NAT across an IP network.

In FIG. 1, client 1, 110, client 2, 102, and client 3, 105, connect to a NAT 120 via an Ethernet 140 and can communicate with, for example, a server 130 across an IP network 150, via the NAT 120. The NAT 120 has an internal address 160 (e.g., 192.168.42.254) and an external IP address 170 (e.g., 159.62.10.150). The internal address 160 is used for the clients (e.g., 102, 105, 110) to communicate with the NAT 120. The external IP address 170 is a public address, which may be assigned by an Internet Service Provider (ISP) and is routable across the IP network 150.

When a packet is sent from a client (e.g., client 110) behind a NAT (e.g., the NAT 120) to a server (e.g., the server 130), it includes a header and a Payload Data Unit (PDU) which is the body of the packet. The header contains the information about the source, including the source address (the private address of the client 110, e.g., 192.168.42.1) and the source port (the port that the client 110 uses to send the packet, e.g., port 4000), and the destination, including the destination address (the IP address of the server 130, e.g., 200.122.111.5) and the destination port (the port on the server side to be used to receive the packet, e.g., port 80). When the packet arrives at the NAT 120, the NAT 120 translates the source information and replaces, in the header, its external IP address (e.g., 159.62.10.150) and a specific port (of the NAT 120) used to transmit the packet (e.g., port 5000). The packet is then routed from the NAT 120 to the server 130 across the IP network 150.

When the server 130 receives the packet, the server 130 recognizes, based on the information in the header that the packet is sent from the NAT 120 (port 5000 at 159.62.10.150). When the server 130 sends a reply packet to the client 110, it uses the information from the received header to construct a header for the reply packet. For example, the header of the reply packet may specify the source information as port 80 at IP addresses 200.122.111.5 and the destination information including both port 5000 at 159.62.10.150 (the external IP address of the NAT 120) and port 4000 at 192.168.42.1 (the private address of the client 110). Using such a header, the reply packet can be routed across the IP network 150 back to the client 110 via the NAT 120.

With the rapid advancement IP networks, more and more communication applications involve real-time multimedia data streaming. For example, Voice over IP (VoIP) applications and IP-based games require 2-way real time data streaming across IP networks. The end points in these applications usually communicate via end-to-end addressing. That is, they inform their counterparts about the source IP address and source port in the PDU part of a packet (instead of in the header). The current NAT based platform, as described in FIG. 1, can not support such applications because a NAT does not examine the PDU part of a packet. That is, in this case, the NAT can not correctly translate the addresses and forward the packets between end points.

Efforts have been made to enable real-time data streaming over NAT based network configuration. Such efforts involve modifying existing NAT configurations. Some approaches make changes to the NAT system so that a special application layer proxy can be incorporated. Using this solution, the special application layer proxy may be invoked to handle any application that requires end-to-end addressing. To deploy this type of solution requires changes to be made to an existing NAT system, which demands skilled personals with network expertise.

A different solution involves the deployment of a dedicated external server to get around an existing NAT system. With this solution, a packet from a private end point behind a NAT is tunneled directly to the dedicated server. Unfortunately, to deploy and to maintain dedicated servers can be very costly.

### BRIEF DESCRIPTION OF THE DRAWINGS

The present invention is further described in terms of exemplary embodiments, which will be described in detail with reference to the drawings. These embodiments are non limiting exemplary embodiments, in which like reference numerals represent similar parts throughout the several views of the drawings, and wherein:

FIG. 1 describes a scheme in which a network address translator uses its IP address to facilitate the communication between a client behind it and a server across a network;

FIG. 2 depicts an exemplary scheme which enables data streaming between a client behind a network address translator and a server, according to an embodiment of the present invention;

FIG. 3 is an exemplary flowchart of a process, in which data streaming between a client behind a network address translator and a server is enabled via UDP priming, according to an embodiment of the present invention;

FIG. 4 is an exemplary flowchart of a process, in which a client behind a network address translator performs UDP priming to facilitate data streaming via the network address translator, according to an embodiment of the present invention;

FIG. 5 is an exemplary flowchart of a process for a server according to an embodiment of the present invention;

FIG. 6 depicts an exemplary scheme which enables data streaming between a client behind a network address translator and a server with reduced latency, according to an embodiment of the present invention;

FIG. 7 is an exemplary flowchart of a process, in which data streaming between a client behind a network address translator and a server is enabled via advanced UDP priming, according to an embodiment of the present invention;

FIG. 8 is an exemplary flowchart of a process, in which a client behind a network address translator performs advanced UDP priming to facilitate data streaming via the network address translator, according to an embodiment of the present invention;

FIG. 9 is an exemplary flowchart of a process for a server according to an embodiment of the present invention;

FIG. 10 depicts an exemplary scheme which enables a server to initiate a call signaling to a client behind a network address translator via a TCP connection, according to an embodiment of the present invention;

FIG. 11 is an exemplary flowchart of a process, in which a server initiates a call signaling through a TCP connection, according to an embodiment of the present invention;

FIG. 12 depicts an exemplary scheme which enables a server to initiate a call signaling to a client behind a network address translator via a UDP connection, according to an embodiment of the present invention;

FIG. 13 is an exemplary flowchart of a process, in which a server initiates a call signaling through a UDP connection, according to an embodiment of the present invention; and

FIG. 14 depicts the exemplary internal structures of both a client behind a NAT and a server and how they interact with each other via the NAT to enable real time 2-way data streaming.

### DETAILED DESCRIPTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

The processing described below may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

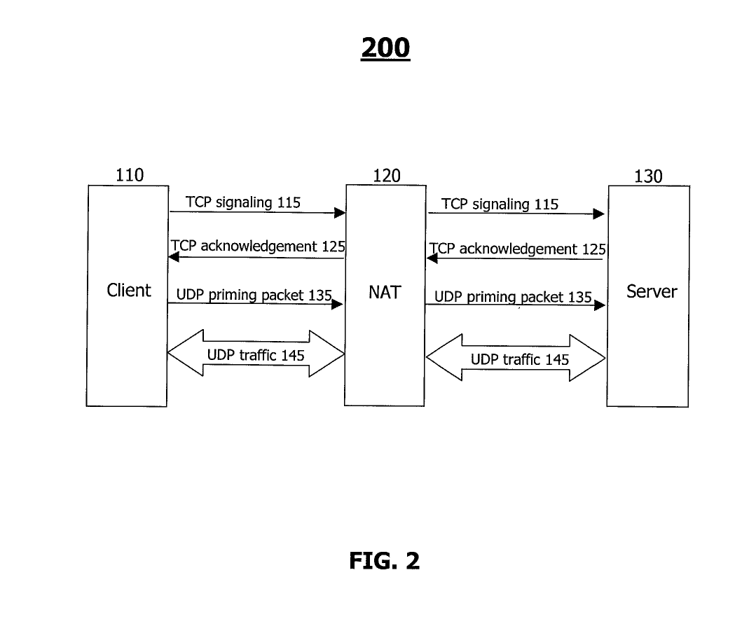

FIG. 2 depicts an exemplary scheme 200 that enables real time data streaming between a private end point behind a network address translator (NAT) 120 and a public end point, according to an embodiment of the present invention. In the exemplary scheme 200, the private end point is instantiated as a client 110 and the public end point is instantiated as a server 130. It will become apparent to those skilled in the art that a private end point merely refers to a device that has an address in a private address space, which may not be routable in an IP network. Similarly, a public end point refers to a device that has an address in a public address space assigned by, for example an ISP, which is routable in an IP network. In general, both a private end point and a public end point can be either a client or a server.

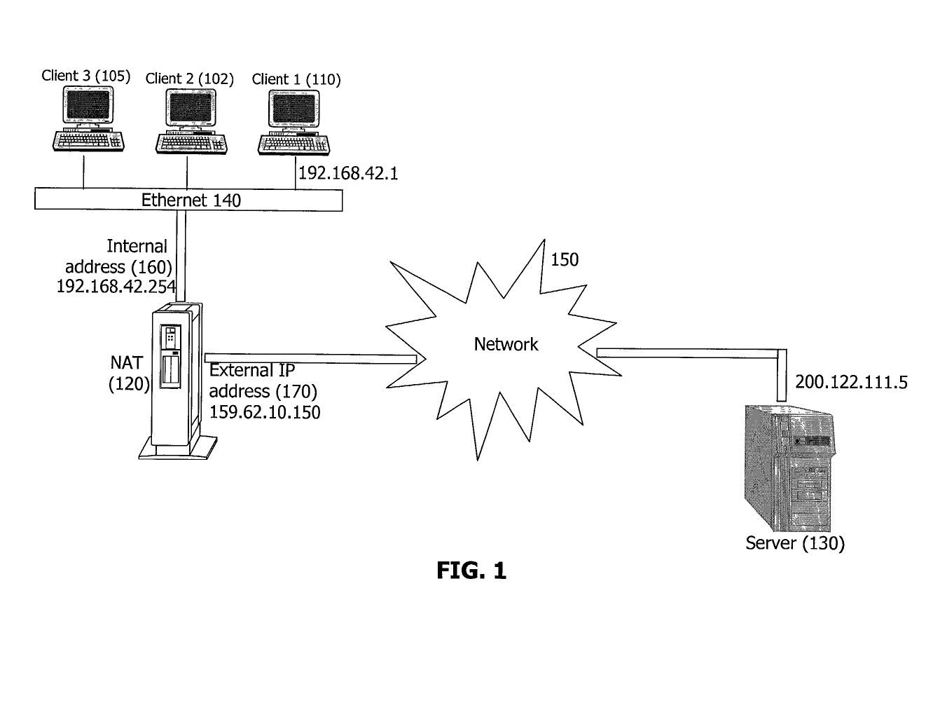

There may be a plurality of clients behind the NAT 120 (only one is shown in FIG. 2) and they may all linked to the NAT 120 in a, for example, Local Area Network (LAN) or a Wide Area Network (WAN), through a connection such as an Ethernet. The NAT 120 and the server 130 may be connected via a network (not shown in FIG. 1). The network between the NAT 120 and the server 130 may be a generic network representing, for example, the Internet or a proprietary network.

The client 110, the NAT 120, and the server 130 may have their own unique addresses. The client 110 communicates with the server 130 through the NAT 120. Information sent from the client 110 to the server 130 is routed through the NAT 120 (and the network between the NAT 120 and the server 130). Information sent from the server 130 to the client 110 is also forwarded through the NAT 120. When the client 110 initiates the communication with the server 130, the NAT 120 uses its external Internet Protocol (IP) address, which is routable across network, to represent the client 110 to forward the information from the client 110 to the server 130. At the same time, the NAT 120 records the correspondence between the internal address of the client 110 and the address of the server 130.

When the server 130 receives the information, forwarded by the NAT 120 on behalf of the client 110, it sends a reply using the IP address of the NAT 120. Based on the recorded address translation information, the NAT 120 recognizes the correspondence between the server 130 and the client 110 and forwards the reply to the client 110. This translation process enables multiple clients behind the NAT 120 to communicate across a network using a common identifiable IP address (of the NAT 120).

In the exemplary scheme 200, to enable real-time data streaming between the client 110 (behind the NAT 120) and the server 130, User Datagram Protocol (UDP) based priming is applied. According to the scheme 200, the client 110 initiates a Transmission Control Protocol (TCP) signaling 115 to establish a connection with the server 130. In the TCP signaling 115, the client 110 may specify in the header the source address (client's address), the destination address (server's address), as well as the TCP port at the destination address. The client 110 further may specify, in the Payload Data Unit (PDU) (or body) of the TCP signaling packet, the client's address and the client's receiving port to be used for real-time data streaming.

When the NAT 120 receives the TCP signaling 115, it examines the header of the TCP signaling 115 and performs address translation to replace the internal address of the client 110 with the external IP address of the NAT 120. The NAT 120 may also record the information related to the destination (i.e., the address and the TCP port of the server 130). The TCP signaling 115, together with the PDU containing the information about the client's address and the streaming port, is then forwarded from the NAT 120, across a network, to the server 130.

When the server 130 receives the TCP signaling 115 from the external IP address of the NAT 120, it examines the PDU part to identify the client's receiving port and the client's address to be used for data streaming. The server 130 then constructs a TCP acknowledgement 125 with a PDU part, in which the information about the server's receiving port to be used for data streaming is specified, and sends the TCP acknowledgement 125 back to the client 110 using the external IP address of the NAT 120.

Upon receiving the TCP acknowledgement 125, the NAT 120 performs the address translation according to the recorded correspondence between the client 110 and the server 130 and forwards the TCP acknowledgement 125 to the client 110. When the client 110 receives the TCP acknowledgement 125, it examines the PDU part to obtain the information about the port on the server side that is specified as the server's receiving port for data streaming.

In the exemplary scheme 200, the client 110 and the server 130 utilize the PDU part of TCP packets to exchange information about the ports on both sides to be used for data streaming. Through such exchange of information, the server 130 is informed of the client's receiving port and the client 110 is informed of the server's receiving port. Information communicated through the PDU part is transparent to the NAT 120 because the NAT 120 examines only the information (e.g., source address and destination address) contained in the header of a TCP packet.

With the exemplary scheme 200, to enable data streaming between the client's port and the server's port, the connection between the two ports is established via UDP priming. To prime a data channel between a port of the client 110 and a port of server 130, the client 110 sends a User Datagram Protocol (UDP) packet as a UDP priming packet 135 from the specified client's receiving port to the specified server's receiving port via the NAT 120. Similarly, the NAT 120 performs the address translation and forwards the UDP priming packet 135 via its external IP address. During the translation, the NAT 120 is made aware of the client's receiving port and the server's receiving port and the NAT 120 records such information. The UDP priming packet 135 may be either a dummy packet or a packet that contains useful information.

When the server 130 receives the UDP priming packet 135 at the specified server's port, the data channel for real time data streaming between the two ports is established. Based on the discrepancy between the specified client's address (and the client's receiving port) and the address from which the UDP priming packet 135 is received, the server 130 recognizes that the client 110 is behind the NAT 120. This means that the server 130 may not be able to reach the client 110 directly. Instead, the address from which the UDP priming packet is received is to be used as the receiving address on the client side whenever the server 130 is to send streaming data to the client 110. Data can then be streamed between the client 110 and the server 130 as UDP traffic 145 through the established data channel via the NAT 120.

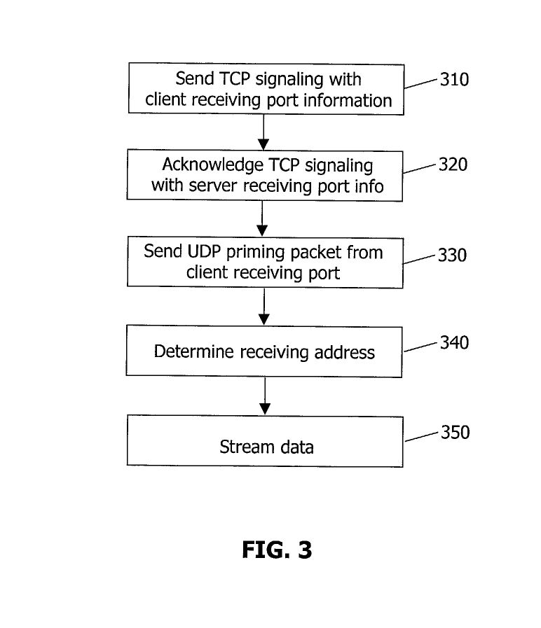

FIG. 3 is an exemplary flowchart of a process, in which data streaming between the client 110 behind the NAT 120 and the server 130 is enabled through UDP priming based on the scheme 200. A TCP signaling packet 115 with its PDU part is first sent, at act 310, from the client 110 to the server 130 via the NAT 120. The PDU contains the information about the client's receiving port. Upon receiving the TCP signaling packet 115, the server 130 sends back, at act 320, a TCP acknowledgement packet 125 with a PDU part containing the information about the server's receiving port to be used for data streaming.

Upon receiving the TCP acknowledgement packet 125, the client 110 obtains the server's receiving port information and sends, at act 330, a UDP priming packet 135, via the NAT 120, to the server's receiving port. When the server 130 receives the UDP priming packet 135, it determines, at act 340, the client's receiving address to be used to stream data to the client 110. The client's receiving address may correspond to the external IP address of the NAT 120, if the UDP priming packet 135 is sent through the NAT 120, or the client's receiving port, if the UDP priming packet 135 is sent directly from the client 110.

In the exemplary scheme 200, as the UDP priming packet 125 is sent through the NAT 120, the receiving address used for the server 130 to stream data to the client 110 corresponds to the external address of the NAT 120. It should be appreciated by those skilled in the art that it is possible that a client may send a UDP priming packet directly to a server and the receiving address of the client, in this case, may map directly to the IP address of the client. Once the receiving addresses on both sides (the client's side and the server's side) are understood, the data is streamed, at act 350, between the client's receiving port and the server's receiving port.

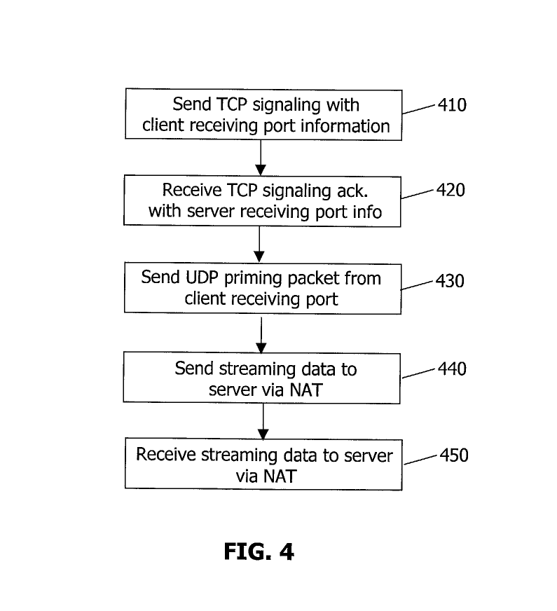

FIG. 4 is an exemplary flowchart of a process, in which the client 110 behind the NAT 120 performs UDP priming to facilitate data streaming via the NAT 120 according to an embodiment of the present invention. The client 110 first sends, at act 410, a TCP signaling with a PDU part containing the information about the receiving port of the client 110 to the server 130 via the NAT 120. The client 110 then receives, at act 420 via the NAT 120, a TCP acknowledgement 125 sent from the server 130. The TCP acknowledgement 125 also includes a PDU part that contains the information about the server's receiving port. Using the given server's receiving port information, the client 110 sends, at act 430, a UDP priming packet 135 from the client's receiving port to the server's receiving port via the NAT 120. Through the UDP priming, the NAT 120 derives the address translation information between the client's receiving port and the server's receiving port. Data can then be streamed between the client 110 and the server 130 via the NAT 120. The client 110 sends, at act 440, streaming data to the server 130 and receives, at act 450, streaming data from the server 130, both through the NAT 120.

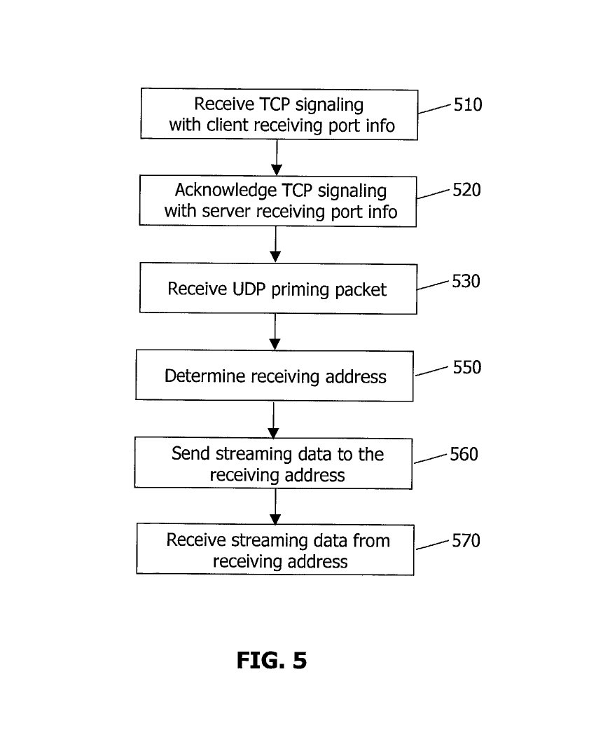

FIG. 5 is an exemplary flowchart of a process for the server 130 according to an embodiment of the present invention. The server 130 first receives, at act 510, a TCP signaling sent from the client 110 and forwarded from the NAT 120. The TCP signaling 115 is sent with a PDU containing the information specifying the receiving port of the client 110 to be used to receive stream data. The server 130 obtains the client's receiving port information and sends back, at act 520, a TCP acknowledgement to the client 110 via the NAT 120. The TCP acknowledgement is sent with a PDU part informing the client 110 about the receiving port on the server side to be used to receive streaming data.

After acknowledging the TCP signaling, the server 130 waits until it receives, at act 530, a UDP priming packet sent, via the NAT 120, from the receiving port of the client i 110. Through the priming, the NAT 120 derives the translation information needed to support data streaming between the receiving port of the client 110 and the receiving port of the server 130. Based on the UDP priming packet, the server 130 then determines, at act 550, the receiving address, through which the server 130 can stream data to the client 110. Data can then be streamed between the client 110 and the server 130 via the NAT 120. The server 130 sends, at act 560, streaming data to the client 110 using the receiving address and receives, at act 570, streaming data from the client 110 from the receiving address.

In the exemplary scheme 200, to enable data streaming between a client behind a NAT and a server, a UDP packet is used to prime the data channel to be used to stream data. Through priming, the NAT 120 is made aware of the client's receiving port so that the information necessary to perform address translation during data streaming can be derived from the priming. In the exemplary scheme 200, the client 110 sends the UDP priming packet only after the client 110 receives the TCP acknowledgement 125 because the client 110 needs the information about the receiving port on the server side, which is specified in the PDU part of the TCP acknowledgement signal. That is, at least a round trip of TCP handshake (TCP signaling and TCP acknowledgement) takes place before data can be streamed in either direction.

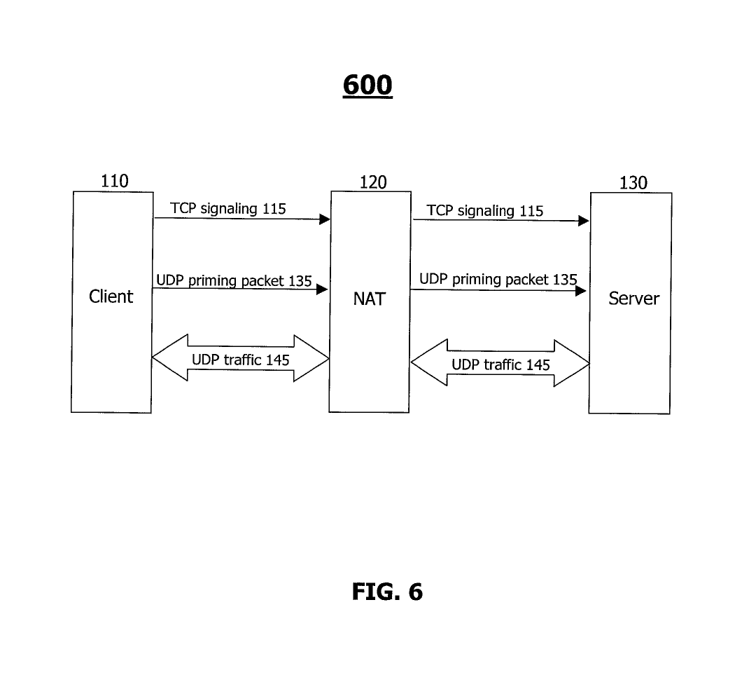

FIG. 6 depicts an exemplary scheme 600, which enables data streaming between the client 110 behind the NAT 120 and the server 130 using UDP priming with reduced latency, according to a different embodiment of the present invention. In the exemplary scheme 600, the server 130 continuously listens to a plurality of receiving ports within a predetermined range and intercepts data sent to any one of these ports. To initiate a 2-way data streaming, the client 110 first sends the TCP signaling 115 to the server 130 via the NAT 120. The TCP signaling 115 includes a PDU part, in which the client 110 specifies the receiving port on the client side to be used to receive streaming data.

The client 110 then sends, from its receiving port, a UDP priming packet to a receiving port of the server 130. That is, with the scheme 600, instead of waiting for the server 130 to notify the client 110 about the server's receiving port for data streaming, the client 110 selects one of the ports that are monitored or listened continuously by the server 130, to be the receiving port on the server side. The UDP priming between the client's receiving port and the selected server's receiving port allows the NAT 120 to derive information that is necessary to enable the address translation, during data streaming, between the client's receiving port and the selected receiving port on the server side.

When the server 130 receives the UDP priming packet 135 at the selected (by the client 110) port within its listening range, it identifies the receiving address to be used to stream data to the receiving port of the client 110. In the exemplary scheme 600, since data streaming may start right after the TCP signaling 115 is sent, the latency is reduced.

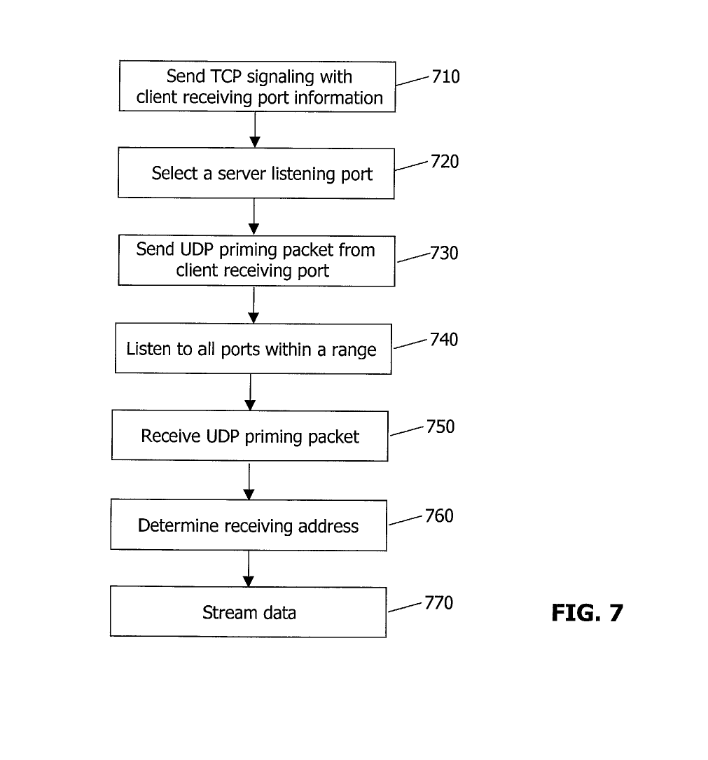

FIG. 7 is an exemplary flowchart of a process, in which data streaming between the client 110 behind the NAT 120 and the server 130 is enabled via UDP priming with reduced latency, according to an embodiment of the present invention. The client 110 initiates a data streaming session by sending, at act 710, a TCP signaling to the TCP port of the server 130 via the NAT 120. The TCP signaling 115 includes a PDU part that contains the information about the receiving port on the client side to be used for data streaming.

The client 110 then selects, at act 720, a port at the server side as the server's receiving port. The server's receiving port is selected so that the port is within a range of ports that are continuously listened by the server 130. A UDP priming packet is sent, at act 730, from the client's receiving port to the selected server's receiving port via the NAT 120.

On the server side, the server 130 continuously listens, at act 740, all the ports within a predetermined range. The UDP priming packet 135, sent from the client 110, is received, at act 750, at the port selected (by the client 110) as the server's receiving port. Based on the received UDP priming packet, the server 130 determines, at act 760, the receiving address to which the server 130 can send streaming data to the client 110. Data streaming is then performed at act 770.

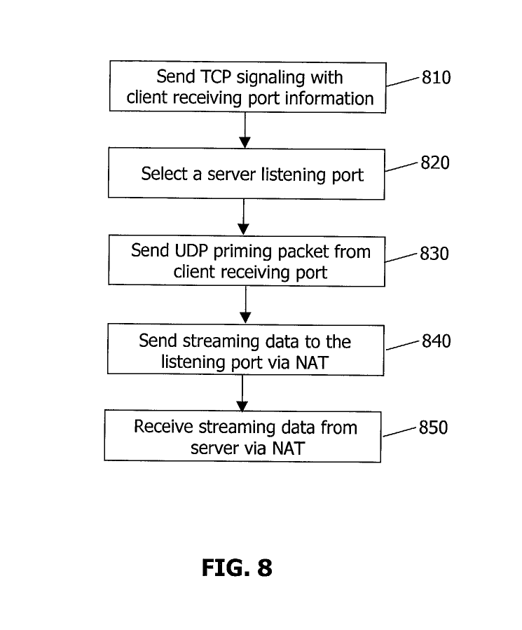

FIG. 8 is an exemplary flowchart of a process, in which the client 110 behind the NAT 120 performs UDP priming to facilitate data streaming with reduced latency via the NAT 120, according to an embodiment of the present invention. The client 110 first sends, at act 810, a TCP signaling 115 to the server 130 via the NAT 120. The TCP signaling 115 includes a PDU part that contains the information specifying the client's receiving port to be used for streaming. The client 110 selects, at act 820, an listening port on the server side to be the receiving port on the server side. The selected port is one of those ports that are continuously monitored by the server 130. The client 110 then primes the streaming channel (from the client's receiving port to the NAT 120 and to the server's receiving port) by sending, at act 830, a UDP priming packet 135 to the selected listening port or the server's receiving port through the NAT 120. The priming allows both the NAT 120 to establish a proper address translation table and the server 130 to determine the receiving address to be used to stream data to the client 110. The client 110 then performs data streaming, which may include both sending, at act 840, streaming data to the server 130 and receiving, at act 850, streaming data from the server 130, both through the NAT 120.

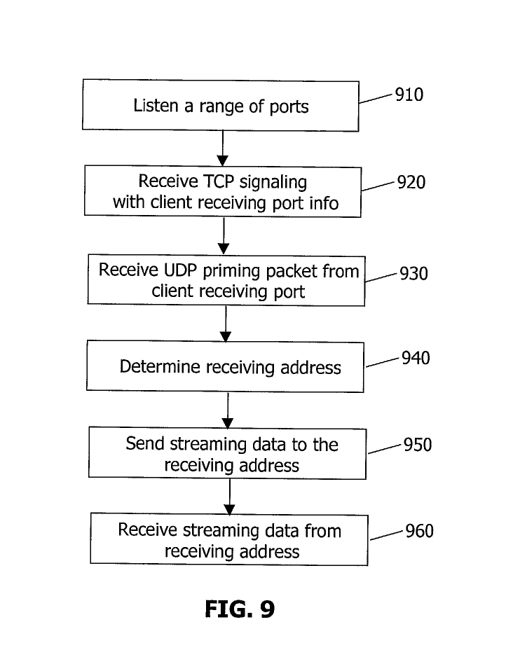

FIG. 9 is an exemplary flowchart of a process for the server 130 that is consistent with the exemplary scheme 600 according to an embodiment of the present invention. The server 130 listens, at act 910, a predetermined range of ports. After the client 110 initiates a TCP signaling with a PDU part, the server 130 receives, at act 920, the TCP signaling packet. The server 130 examines the TCP packet and extracts the information about the client's address and its receiving port. The server 130 then keeps listening to different ports until a UDP priming packet from the client 110 is received, at act 930, at one of the listening ports. Based on the UDP priming packet, the server 130 determines, at act 940, the receiving address (e.g., NAT's external IP address) to be used to stream data to the client 110. Data can then be streamed between the client 110 and the server 130 in both directions. This includes sending, at act 950, streaming data from the server 130 to the client 110 using the receiving address (e.g., NAT's external IP address) and receiving, at act 960, streaming data from the client 110 via the receiving address.

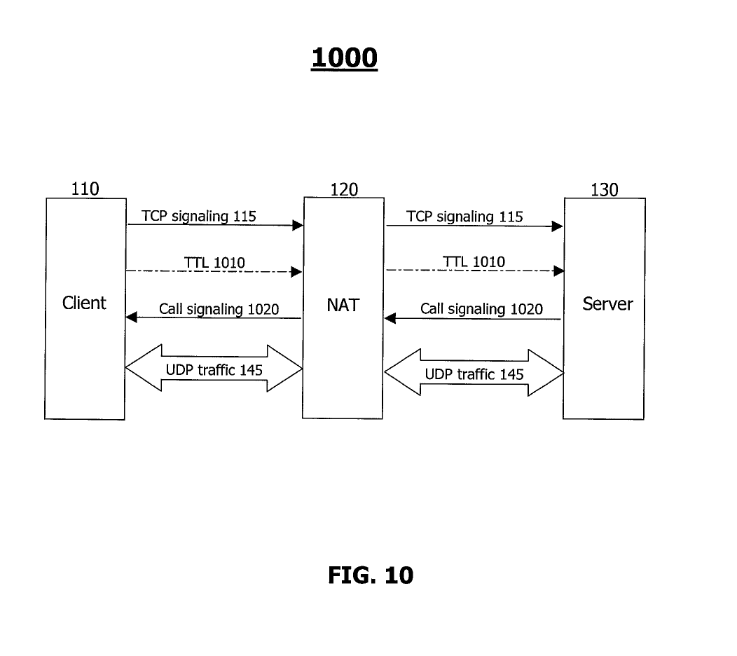

In both the scheme 200 and the scheme 600, the client 110 initiates the data streaming connection. The server 130 responds to the client's initiation. FIG. 10 depicts an exemplary scheme 1000, which enables the server 130 to initiate a call signaling to the client 110 behind the NAT 120 via a TCP connection, according to an embodiment of the present invention. With the scheme 1000, a TCP connection is established and maintained between the client 110 and the server 130 through the NAT 120. Through the continuously -maintained TCP connection, the server 130 may send a call signaling to the client 110 to initiate a call.

To establish a TCP connection, the client 110 sends a TCP signaling 115 to the server 130 via the NAT 120. The client 110 informs the server 130, via the PDU part of the TCP signaling, a receiving port on the client side to be used for a future call (or data streaming). To maintain the TCP connection, the client 110 periodically sends a packet to the server 130. For example, the client 110 may send a Time-To-Live signal (TTL) 1010 to the server 130 via the NAT 120 according to some predetermined periodicity. Such regularly sent signals keep the TCP connection alive. The packets may also be sent according to some different schedules. For instance, packets may be sent whenever the client 110 is idle.

With a continuously maintained TCP connection, the address translation information in the NAT 120 is kept up to date. When the server 130 needs to call the client 110, it utilizes the TCP connection to initiate the call by sending a call signaling 1020 to the client 110.

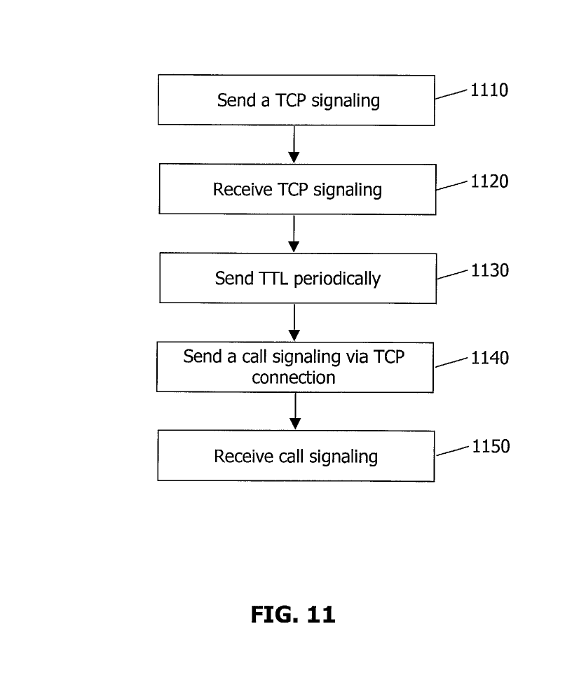

FIG. 11 is an exemplary flowchart of a process, in which the server 130 initiates a call signaling to the client 110 through a continuously maintained TCP connection, according to an embodiment of the present invention. The client 110 first sends, at act 110, a TCP signaling to the server 130 via the NAT 120. The server 130 receives, at act 1120, the TCP signaling. To maintain the TCP connection, the client 110 periodically sends, at act 1130, TTL packets to the server 130. Through the TCP connection, the server 130 initiates, at act 1140, a call signaling to the client 110. The 2-way communication, initiated by the server 130, may start when the client 110 receives, at act 1150, the call signaling from the server 130.

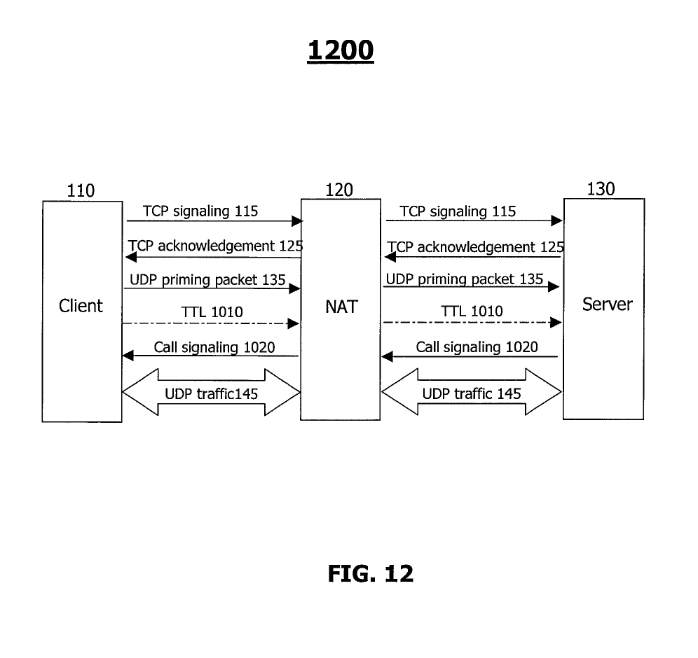

FIG. 12 depicts a different exemplary scheme 1200, which enables the server 130 to initiate a call signaling to the client 110 behind the NAT 120 via a UDP connection, according to an embodiment of the present invention. In the scheme 1200, a UDP connection between a client sitting behind a NAT is established via UDP priming. To allow the server 130 to initiate a call at any time, the UDP connection is continuously maintained. This is achieved by periodically sending packets through the UDP connection. For example, TTL packets may be sent from the client 110 to the server 130 according to a pre-determined periodicity. The packets may also be sent according to some different schedules. For instance, packets may be sent whenever the client 110 is idle.

With the continuously maintained UDP connection, the server 130 may initiate a call whenever it is needed through the UDP connection. When the need arises, the server 130 sends a call signaling 1020 to the client 110 and a 2-way communication may be activated based on the call signaling.

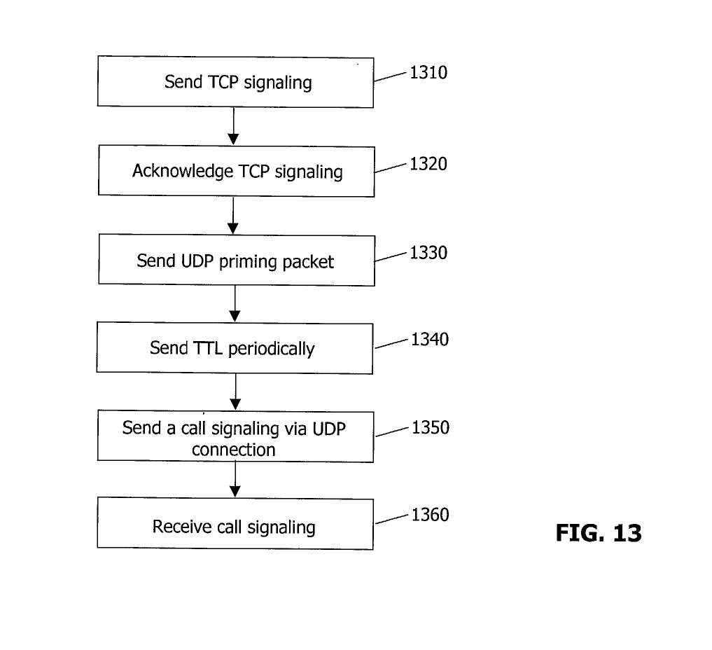

FIG. 13 is an exemplary flowchart for a process of the scheme 1200, in which the server 130 initiates a call signaling through a UDP connection. The client 110 sends, at act 1310, a TCP signaling to the server 130 via the NAT 120. Upon receiving the TCP signaling, the server 130 returns, at act 1320, a TCP acknowledgement back to the client 110 through the NAT 120. To establish a UDP connection with the server 130, the client 110 sends, at act 1330, a UDP priming packet to the server 130 via the NAT 120. To maintain the UDP connection, the client 110 sends, at act 1340, packets to the server 130 according to some predetermined intervals. Through this continuously maintained UDP connection, the server 130 may initiate a call signaling whenever such a need arises. A call signaling is sent, at act 1350, from the server 130 to the client 110 via the NAT 120. When the client 110 receives, at act 1360, the call signaling from the server 130, a 2-way communication can be started via the UDP connection.

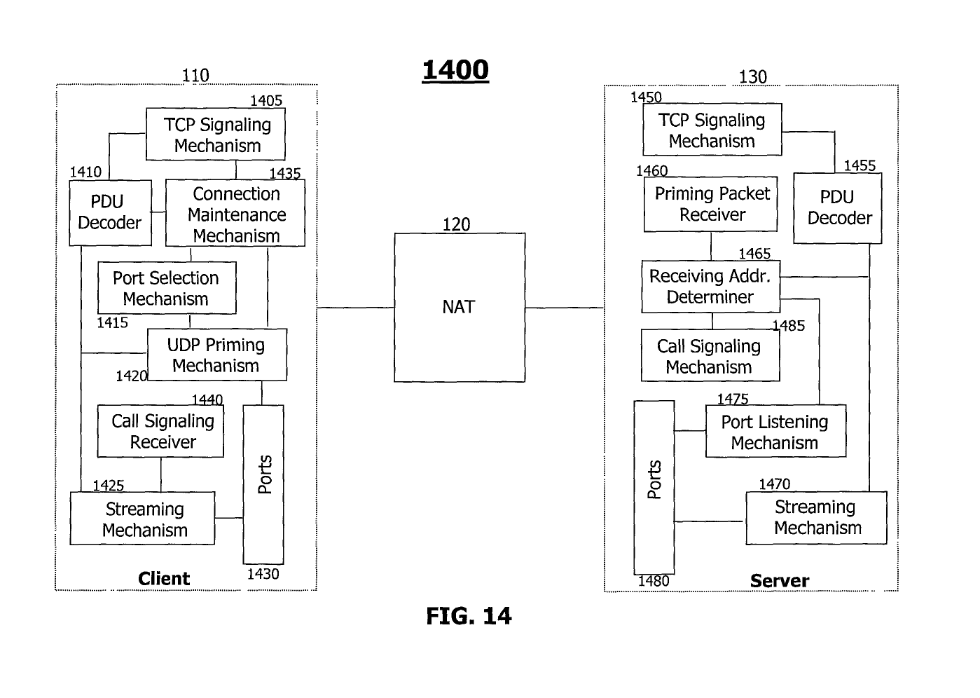

FIG. 14 depicts the exemplary internal structures of both the client 110 and the server 130 and how they interact with each other via the NAT 120 to enable real time 2-way data streaming. In system 1400, the client 110 partially comprises a TCP signaling mechanism 1405, a PDU decoder 1410, a UDP priming mechanism 1420, a streaming mechanism 1425, at least one port 1430 associated with the client 110, a port selection mechanism 1415, a connection maintenance mechanism 1435, and a call signaling receiver 1440.

The TCP signaling mechanism 1405 is responsible for sending the TCP signaling 115 to the server 130 (via the NAT 120) and receiving the TCP acknowledgement 125 from the server 130 (via the NAT 120). The TCP signaling mechanism 1405 may also be responsible for constructing the TCP signaling packet 115 with the PDU part containing the information about a client's receiving port (one of the port in 1430). The PDU decoder 1410 decodes the PDU part of the TCP acknowledgement packet 125 to extract the information about the server's receiving port.

Based on the information about the server's receiving port, the UDP priming mechanism 1420 sends the UDP priming packet 135 to the server's receiving port via the NAT 120. The streaming mechanism 1425 performs data streaming, using the client's receiving port in 1430, between the client 110 and the server 130.

To support data streaming with reduced latency, the port selection mechanism 1415 selects, after the TCP signaling 115 is sent to the server 130, a listening port on the server side as the server's receiving port and then triggers the UDP priming mechanism 1420 to send the UDP priming packet 135 to the selected receiving port.

To support the exemplary schemes 1000 and 1200, the connection maintenance mechanism 1435 in client 110 periodically sends a packet to the server 130 to maintain a connection. Such a connection may be a TCP connection or a UDP connection. The packet sent to the server 130 may be a TTL packet or some other types of packets. The connection maintenance mechanism 1435 may have an internal clock that controls the periodicity based on which the packets are sent. It may also have a sub mechanism that computes an irregular schedule to send the packets.

When the server 130 initiates a call through the continuously maintained connection, the call signaling receiver 1440 intercepts the call signaling and may then trigger the streaming mechanism 1425 to start data streaming.

In system 1400, the server 130 partially comprises various counterpart mechanisms, including a TCP signaling mechanism 1450, a PDU decoder 1455, a priming packet receiver 1460, a streaming mechanism 1470, at least one port 1480 associated with the server 130, a port listening mechanism 1475, and a call signaling mechanism 1485. The server 130 further includes a receiving address determiner 1465 that determines the receiving address through which the server 130 streams data to the client's receiving port.

Symmetric to its counterpart, the server's TCP signaling mechanism 1450 receives the TCP signaling 115 from the client 110 and sends the TCP acknowledgement 125 to the client 110. The TCP signaling mechanism 1450 may also be responsible for constructing the TCP acknowledgement 125 with the information about the server's receiving port. When the TCP signaling 115 is received, the PDU decoder 1455 in the server 130 extracts the information about the client's receiving port from the PDU part of the packet and such information may be later used to determine the receiving address for streaming.

The priming packet receiver 1460 receives the UDP priming packet sent from the client 110 via the NAT 120 and may pass relevant information to the receiving address determiner 1465. For example, such information may include the IP address from which the UDP priming packet is received and may be used, together with the information about the client's receiving port, by the receiving address determiner 1465 to determine the receiving address. For instance, if the receiving address determiner 1465 recognizes that the client 110 is behind a NAT, the client's internal address and its corresponding receiving port will not be used as the receiving address.

Once the receiving address is determined, the streaming mechanism 1470 may be triggered to start data streaming using the server's receiving port (which is one of the port in 1480). To support data streaming with reduced latency (according to the exemplary scheme 600), the server 130 may listen a plurality of ports within a pre-determined range (which may correspond to a portion of the ports in 1480) via the port listening mechanism 1475. When a UDP priming packet is received at one of the listening port (it is a port selected by the port selection mechanism as the server's receiving port), the port listening mechanism 1475 may send relevant information associated with the UDP priming packet (e.g., the address from where the priming packet is received) to the receiving address determiner 1465 to determine the receiving address which can be used to perform data streaming.

The call signaling mechanism 1485 facilitates the exemplary scheme 1000 and 1200, in which the server 130 initiates a call to the client 110 through a continuously maintained connection. The call signaling mechanism 1485 construct a call signaling at appropriate time and sends the call signaling to the client 110 through the maintained connection via the NAT 120. Such a connection may be either a TCP connection (the exemplary scheme 1000) or a UDP connection (the exemplary scheme 1200).

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method, comprising:
sending a first signaling from a first address to a second address, using an public address of a network address translator, with the information about a first port at the first address;
sending, upon receiving the first signaling, a second signaling from the second address to the first address, via the public address, with the information about a second port at the second address;
sending, upon receiving the second signaling, a packet from the first port at the first address to the second port at the second address via the public address to establish a data channel between the first port of the first address and the second port of the second address; and
streaming data between the first port at the first address and the second port at the second address via the data channel using a receiving address.

2. The method according to claim 1, wherein
the first address corresponds to a client connected to the network address translator that represents the client using its public address; and
the second address corresponds to a server that communicates with the client through the public address of the network address translator.

3. The method according to claim 1, further comprising:
determining, upon receiving the packet and prior to the streaming data, the receiving address to be either the public address, if the address from which the packet is received is not the first address, or the first address, if the address from which the packet is received is the first address.

4. The method according to claim 3, further comprising:
sending, through the receiving address, a packet periodically according to a predetermined interval from the first port to the second port to maintain the data channel;
sending a call signaling from the second port of the second address to the first port of the first address, via the data channel and through the receiving address, to initiate a data streaming session before the streaming data.

5. A method, comprising:
sending a first signaling from a first address to a second address, using an public address of a network address translator, with the information about a first port at the first address;
receiving, at the first address, a second signaling from the second address to acknowledge the first signaling, via the public address, with the information about a second port at the second address; and
sending, upon receiving the second signaling, a packet from the first port at the first address to the second port at the second address using the public address to establish a data channel between the first port and the second port;
sending, from the first port at the first address, streaming data to the second port at the second address through the data channel using the public address; and
receiving, at the first port at the first address, streaming data from the second port at the second address through the data channel via the public address.

6. The method according to claim 5, further comprising:
sending a packet periodically according to a predetermined interval from the first port of the first address to the second port of the second address to maintain the data channel;
receiving a call signaling, sent from the second port to the first port via the data channel to initiate a data streaming session, before the streaming data.

7. A method, comprising:
receiving a first signaling sent from a first address to a second address, via a public address of a network address translator, with the information about a first port at the first address;
sending, from the second address, a second signaling to acknowledge the first signaling, via the public address, with the information about a second port at the second address;
receiving a packet sent from the first port at the first address to the second port of the second address to establish a data channel between the first port and the second port;
receiving, at the second port at the second address, streaming data from the first port at the first address through the data channel via a receiving address; and
sending, from the second port at the second address, streaming data to the first port at the first address through the data channel using the receiving address.

8. The method according to claim 7, further comprising:
determining the receiving address to be either the public address, if the address from which the packet is received is not the first address, or the first address, if the address from which the packet is received is the first address; and
sending, before the streaming data, a call signaling from the second port of the second address to the first port of the first address to initiate a data streaming session via the data channel through the receiving address.

9. A method, comprising:
sending a first signaling from a first address to a second address, using an public address of a network address translator, with the information about a first port at the first address;
selecting an listening port at the second address from a plurality of ports that are listened at the second address;
sending a packet from the first port at the first address to the listening port at the second address to establish a data channel between the first port and the listening port;
receiving the packet at the listening port at the second address; and
starting data streaming between the first port at the first address and the second port at the second address via the data channel using a receiving address.

10. The method according to claim 9, wherein
the first address corresponds to a client connected to the network address translator that represents the client using its public address; and
the second address corresponds to a server that communicates with the client through the public address of the network address translator.

11. The method according to claim 9, further comprising:
sending a packet periodically according to a pre-determined interval from the first port of the first address to the listening port of the second address to maintain the data channel;
determining, upon receiving the packet at the listening port, the receiving address to be either the public address, if the address from which the packet is received is not the first address, or the first address, if the address from which the packet is received is the first address;
sending, before the starting data streaming, a call signaling from the listening port of the second address to the first port of the first address to initiate a data streaming session via the data channel through the receiving address.

12. A method, comprising:
sending a first signaling from a first address to a second address, using an public address of a network address translator, with the information about a first port at the first address;
selecting an listening port at the second address within a range of ports that are listened at the second address;
sending a packet from the first port at the first address to the listening port at the second address to establish a data channel between the first port and the listening channel;
sending, from the first port at the first address, streaming data to the second port at the second address through the data channel using the public address; and
receiving, at the first port at the first address, streaming data from the second port at the second address through the data channel via the public address.

13. The method according to claim 12, further comprising:
sending a packet periodically according to a predetermined interval from the first port of the first address to the listening port of the second address to maintain the data channel;
receiving a call signaling, sent from the listening port to the first port via the data channel to initiate a data streaming session, before the starting data streaming.

14. A method, comprising:
listening to a plurality of ports;
receiving a packet, sent from a first port at a first address to a second address, at one of the plurality of ports at the second address to establish a data channel between the first port and an listening port at which the packet is received;
determining, upon receiving the packet, a receiving address that represents the first port of the first address;
receiving, at the second port at the second address, streaming data from the first port at the first address through the data channel via a receiving address; and
sending, from the second port at the second address, streaming data to the first port at the first address through the data channel using the receiving address.

15. The method according to claim 14, further comprising:
receiving, at the listening port, a packet periodically according to a predetermined interval sent from the first port of the first address via the data channel through the receiving address;
sending a call signaling, from the listening port to the first port through the receiving address and via the data channel to initiate a data streaming session, before the starting data streaming.

16. A method, comprising:
issuing a first signaling from a first address to a second address via a public address of a network address translator to establish a data channel between the first address and the second address;
receiving the first signaling at the second address;
maintaining the data channel; and
sending a call signaling from the second address to the first address via the data channel to initiate a data streaming session; and
starting data streaming via the data channel.

17. The method according to claim 16, wherein
the first address corresponds to a client connected to the network address translator that represents the client using its public address; and
the second address corresponds to a server that communicates with the client through the public address of the network address translator.

18. The method according to claim 16, wherein the maintaining comprises:
generating a signal periodically according to a predetermined interval; and
sending the signal, generated by the generating, from the first address to the second address via the network address translator.

19. A computer-readable medium encoded with a program, the program, when executed, causing:
sending a first signaling from a first address to a second address, using an public address of a network address translator, with the information about a first port at the first address;
sending, upon receiving the first signaling, a second signaling from the second address to the first address, via the public address, with the information about a second port at the second address;
sending, upon receiving the second signaling, a packet from the first port at the first address to the second port at the second address via the public address to establish a data channel between the first port of the first address and the second port of the second address; and
streaming data between the first port at the first address and the second port at the second address via the data channel using a receiving address.

20. The medium according to claim 1, the program, when executed, further causing:
determining, upon receiving the packet and prior to the streaming data, the receiving address to be either the public address, if the address from which the packet is received is not the first address, or the first address, if the address from which the packet is received is the first address.

21. The medium according to claim 20, the program, when executed, further causing:
sending, through the receiving address, a packet periodically according to a predetermined interval from the first port to the second port to maintain the data channel;
sending a call signaling from the second port of the second address to the first port of the first address, via the data channel and through the receiving address, to initiate a data streaming session before the streaming data.

22. A computer-readable medium encoded with a program, the program, when executed, causing:
sending a first signaling from a first address to a second address, using an public address of a network address translator, with the information about a first port at the first address;
receiving, at the first address, a second signaling from the second address to acknowledge the first signaling, via the public address, with the information about a second port at the second address;
sending, upon receiving the second signaling, a packet from the first port at the first address to the second port at the second address using the public address to establish a data channel between the first port and the second port;
sending, from the first port at the first address, streaming data to the second port at the second address through the data channel using the public address; and
receiving, at the first port at the first address, streaming data from the second port at the second address through the data channel via the public address.

23. The medium according to claim 22, the program, when executed, further causing:
sending a packet periodically according to a pre-determined interval from the first port of the first address to the second port of the second address to maintain the data channel;
receiving a call signaling, sent from the second port to the first port via the data channel to initiate a data streaming session, before the streaming data.

24. A computer-readable medium encoded with a program, the program, when executed, causing:
receiving a first signaling sent from a first address to a second address, via a public address of a network address translator, with the information about a first port at the first address;
sending, from the second address, a second signaling to acknowledge the first signaling, via the public address, with the information about a second port at the second address;
receiving a packet sent from the first port at the first address to the second port of the second address to establish a data channel between the first port and the second port;
receiving, at the second port at the second address, streaming data from the first port at the first address through the data channel via a receiving address; and
sending, from the second port at the second address, streaming data to the first port at the first address through the data channel using the receiving address.

25. The medium according to claim 24, the program, when executed, further causing:
determining the receiving address to be either the public address, if the address from which the packet is received is not the first address, or the first address, if the address from which the packet is received is the first address; and
sending, before the streaming data, a call signaling from the second port of the second address to the first port of the first address to initiate a data streaming session via the data channel through the receiving address.

26. A computer-readable medium encoded with a program, the program, when executed, causing:
sending a first signaling from a first address to a second address, using an public address of a network address translator, with the information about a first port at the first address;
selecting an listening port at the second address from a plurality of ports that are listened at the second address;
sending a packet from the first port at the first address to the listening port at the second address to establish a data channel between the first port and the listening port;
receiving the packet at the listening port at the second address; and
starting data streaming between the first port at the first address and the second port at the second address via the data channel using a receiving address.

27. The medium according to claim 26, the program, when executed, further causing:
sending a packet periodically according to a pre-determined interval from the first port of the first address to the listening port of the second address to maintain the data channel;
determining, upon receiving the packet at the listening port, the receiving address to be either the public address, if the address from which the packet is received is not the first address, or the first address, if the address from which the packet is received is the first address;
sending, before the starting data streaming, a call signaling from the listening port of the second address to the first port of the first address to initiate a data streaming session via the data channel through the receiving address.

28. A computer-readable medium encoded with a program, the program, when executed, causing:
sending a first signaling from a first address to a second address, using an public address of a network address translator, with the information about a first port at the first address;
selecting an listening port at the second address within a range of ports that are listened at the second address;
sending a packet from the first port at the first address to the listening port at the second address to establish a data channel between the first port and the listening channel;
sending, from the first port at the first address, streaming data to the second port at the second address through the data channel using the public address; and
receiving, at the first port at the first address, streaming data from the second port at the second address through the data channel via the public address.

29. The medium according to claim 28, the program, when executed, further causing:
sending a packet periodically according to a pre-determined interval from the first port of the first address to the listening port of the second address to maintain the data channel;
receiving a call signaling, sent from the listening port to the first port via the data channel to initiate a data streaming session, before the starting data streaming.

30. A computer-readable medium encoded with a program, the program, when executed, causing:
listening to a plurality of ports;
receiving a packet, sent from a first port at a first address to a second address, at one of the plurality of ports at the second address to establish a data channel between the first port and an listening port at which the packet is received;
determining, upon receiving the packet, a receiving address that represents the first port of the first address;
receiving, at the second port at the second address, streaming data from the first port at the first address through the data channel via a receiving address; and
sending, from the second port at the second address, streaming data to the first port at the first address through the data channel using the receiving address.

31. The medium according to claim 30, the program, when executed, further causing:
receiving, at the listening port, a packet periodically according to a pre-determined interval sent from the first port of the first address via the data channel through the receiving address;
sending a call signaling, from the listening port to the first port through the receiving address and via the data channel to initiate a data streaming session, before the starting data streaming.

32. A computer-readable medium encoded with a program, the program, when executed, causing:
issuing a first signaling from a first address to a second address via a public address of a network address translator to establish a data channel between the first address and the second address;
receiving the first signaling at the second address;
maintaining the data channel; and
sending a call signaling from the second address to the first address via the data channel to initiate a data streaming session; and
starting data streaming via the data channel.

33. The medium according to claim 32, wherein the maintaining comprises:
generating a signal periodically according to a pre-determined interval; and
sending the signal, generated by the generating, from the first address to the second address via the network address translator.

34. A system, comprising:
a network address translator having a public address for translating between an address and the public address;
a client, connecting to the network address translator using a first address, representing the client, for performing data streaming via the network address translator using the translated public address; and
a server, connecting to the network address translator using a second address, representing the server, for performing data streaming with the client behind the network address translator, the data streaming between the client and the server being enabled via user datagram protocol priming.

35. The system according to claim 34, wherein the client further comprises:
a transmission control protocol signaling mechanism for sending a first signaling via the network address translator to the server to initiate a connection and for receiving a second signaling from the server via the network address translator to acknowledge the establishment of the connection, the first signaling containing the information about a first port at the first address to be used for the data streaming, the second signaling containing the information about a second port at the second address to be used for the data streaming;
a payload data unit decoder for decoding the second signaling to derive the second port at the second address;
a user datagram protocol priming mechanism for sending, from the first port at the first address, a packet to the second port at the second address via the network address translator to establish a data connection between the first port and the second port; and
a streaming mechanism for performing the data streaming through the data channel via the network address translator.

36. The system according to claim 35, wherein the server comprises:
a transmission control protocol signaling mechanism for receiving the first signaling from the client via the network address translator and for sending the second signaling via the network address translator to acknowledge the establishment of the connection, the second signaling being sent with the information about the second port at the second address to be used for the data streaming;
a payload data unit decoder for decoding the first signaling to derive the first port at the second address;
a user datagram protocol priming packet receiver for receiving the packet sent from the first port at the second address via the network address translator;
a receiving address determiner for determining a receiving address, through which the server streams data to the client; and
a streaming mechanism for performing the data streaming through the data channel using the receiving address.

37. The system according to claim 36, wherein
the server further includes a port listening mechanism for listening at least one port within a pre-determined range; and
the client further includes a port selection mechanism for selecting an listening port at the second address to be the receiving port of the server for the data streaming, the listening port being selected from the pre-determined range.

38. The system according claim 37, wherein
the client further comprises:
a connection maintenance mechanism for maintaining a connection with the server by sending a packet periodically to the server via the network address translator; and
a call signaling receiver for receiving a call signaling sent from the server via the connection, kept alive by the connection maintanence mechanism, to initiate the data streaming; and
the server further includes a call signaling mechanism for sending the call signaling to the client to initiate the data streaming.
